(19) United States
(12) Patent Application Publication
(10) Pub. No.: US 2005/0219240 A1
(43) Pub. Date: Oct. 6, 2005

(54) Horizontal perspective hands-on simulator

(76) Inventors: Michael A. Vesely, Santa Cruz, CA (US); Nancy Clemens, Santa Cruz, CA (US)

Correspondence Address: Tue Nguyen, 496 Olive Ave., Fremont, CA, 94539, US

(21) Appl. No.: 11/098,667

(22) Filed: Apr. 4, 2005

Related U.S. Application Data
(60) Provisional application No. 60/559,780, filed on Apr. 5, 2004.

(51) Int. Cl. G06T 15/00

(52) U.S. Cl. 345/419

(57) ABSTRACT

Thus the present invention discloses a hands-on simulator system using horizontal perspective display. The hands-on simulator system comprises a real time electronic display that can project horizontal perspective images into the open space and a peripheral device that allow the end user to manipulate the images with hands or hand-held tools.

This application claims priority from U.S. provisional application Ser. No. 60/559,780 filed Apr. 5, 2004, which is incorporated herein by reference.

### FIELD OF INVENTION

This invention relates to a three-dimensional simulator system, and in particular, to a hands-on computer simulator system capable of operator's interaction.

### BACKGROUND OF THE INVENTION

Three dimensional (3D) capable electronics and computing hardware devices and real-time computer-generated 3D computer graphics have been a popular area of computer science for the past few decades, with innovations in visual, audio and tactile systems. Much of the research in this area has produced hardware and software products that are specifically designed to generate greater realism and more natural computer-human interfaces. These innovations have significantly enhanced and simplified the end-user's computing experience. Ever since humans began to communicate through pictures, they faced a dilemma of how to accurately represent the three-dimensional world they lived in. Sculpture was used to successfully depict three-dimensional objects, but was not adequate to communicate spatial relationships between objects and within environments. To do this, early humans attempted to “flatten” what they saw around them onto two-dimensional, vertical planes (e.g. paintings, drawings, tapestries, etc.). Scenes where a person stood upright, surrounded by trees, were rendered relatively successfully on a vertical plane. But how could they represent a landscape, where the ground extended out horizontally from where the artist was standing, as far as the eye could see?

The answer is three dimensional illusions. The two dimensional pictures must provide a numbers of cues of the third dimension to the brain to create the illusion of three dimensional images. This effect of third dimension cues can be realistically achievable due to the fact that the brain is quite accustomed to it. The three dimensional real world is always and already converted into two dimensional (e.g. height and width) projected image at the retina, a concave surface at the back of the eye. And from this two dimensional image, the brain, through experience and perception, generates the depth information to form the three dimension visual image from two types of depth cues: monocular (one eye perception) and binocular (two eye perception). In general, binocular depth cues are innate and biological while monocular depth cues are learned and environmental.

The major binocular depth cues are convergence and retinal disparity. The brain measures the amount of convergence of the eyes to provide a rough estimate of the distance since the angle between the line of sight of each eye is larger when an object is closer. The disparity of the retinal images due to the separation of the two eyes is used to create the perception of depth. The effect is called stereoscopy where each eye receives a slightly different view of a scene, and the brain fuses them together using these differences to determine the ratio of distances between nearby objects.

Binocular cues are very powerful perception of depth. However, there are also depth cues with only one eye, called monocular depth cues, to create an impression of depth on a flat image. The major monocular cues are: overlapping, relative size, linear perspective and light and shadow. When an object is viewed partially covered, this pattern of blocking is used as a cue to determine that the object is farther away. When two objects known to be the same size and one appears smaller than the other, this pattern of relative size is used as a cue to assume that the smaller object is farther away. The cue of relative size also provides the basis for the cue of linear perspective where the farther away the lines are from the observer, the closer together they will appear since parallel lines in a perspective image appear to converge towards a single point. The light falling on an object from a certain angle could provide the cue for the form and depth of an object. The distribution of light and shadow on objects is a powerful monocular cue for depth provided by the biologically correct assumption that light comes from above.

Perspective drawing, together with relative size, is most often used to achieve the illusion of three dimension depth and spatial relationships on a flat (two dimension) surface, such as paper or canvas. Through perspective, three dimension objects are depicted on a two dimension plane, but “trick” the eye into appearing to be in three dimension space. The first theoretical treatise for constructing perspective, Depictura, was published in the early 1400's by the architect, Leone Battista Alberti. Since the introduction of his book, the details behind “general” perspective have been very well documented. However, the fact that there are a number of other types of perspectives is not well known. Some examples are military 1, cavalier 2, isometric 3, dimetric 4, central perspective 5 and two-point perspective 6 as shown in FIG. 1.

Of special interest is the most common type of perspective, called central perspective 5, shown at the bottom left of FIG. 1. Central perspective, also called one-point perspective, is the simplest kind of “genuine” perspective construction, and is often taught in art and drafting classes for beginners. FIG. 2 further illustrates central perspective. Using central perspective, the chess board and chess pieces look like three dimension objects, even though they are drawn on a two dimensional flat piece of paper. Central perspective has a central vanishing point 21, and rectangular objects are placed so their front sides are parallel to the picture plane. The depth of the objects is perpendicular to the picture plane. All parallel receding edges run towards a central vanishing point. The viewer looks towards this vanishing point with a straight view. When an architect or artist creates a drawing using central perspective, they must use a single-eye view. That is, the artist creating the drawing captures the image by looking through only one eye, which is perpendicular to the drawing surface.

The vast majority of images, including central perspective images, are displayed, viewed and captured in a plane perpendicular to the line of vision. Viewing the images at angle different from 90° would result in image distortion, meaning a square would be seen as a rectangle when the viewing surface is not perpendicular to the line of vision.

Central perspective is employed extensively in 3D computer graphics, for a myriad of applications, such as scientific, data visualization, computer-generated prototyping, special effects for movies, medical imaging, and architecture, to name just a few. One of the most common and well-known 3D computing applications is 3D gaming, which is used here as an example, because the core concepts used in 3D gaming extend to all other 3D computing applications.

FIG. 3 is a simple illustration, intended to set the stage by listing the basic components necessary to achieve a high level of realism in 3D software applications. A team of software developers 31 creates a 3D game development 32, and ports it to an application package 33, such as a CD. At its highest level, 3D game development 32 consists of four essential components:
1. Design 34: Creation of the game's story line and game play
2. Content 35: The objects (figures, landscapes, etc.) that come to life during game play
3. Artificial Intelligence (AI) 36: Controls interaction with the content during game play
4. Real-time computer-generated 3D graphics engine (3D graphics engine) 37: Manages the design, content, and AI data. Decides what to draw, and how to draw it, then renders (displays) it on a computer monitor

A person using a 3D application, such as a game, is in fact running software in the form of a real-time computer-generated 3D graphics engine. One of the engine's key components is the renderer. Its job is to take 3D objects that exist within computer-generated world coordinates x, y, z, and render (draw/display) them onto the computer monitor's viewing surface, which is a flat (2D) plane, with real world coordinates x, y.

FIG. 4 is a representation of what is happening inside the computer when running a 3D graphics engine. Within every 3D game there exists a computer-generated 3D “world.” This world contains everything that could be experienced during game play. It also uses the Cartesian coordinate system, meaning it has three spatial dimensions x, y, and z. These three dimensions are referred to as “virtual world coordinates” 41. Game play for a typical 3D game might begin with a computer-generated-3D earth and a computer-generated-3D satellite orbiting it. The virtual world coordinate system enables the earth and satellite to be properly positioned in computer-generated x, y, z space.

As they move through time, the satellite and earth must stay properly synchronized. To accomplish this, the 3D graphics engine creates a fourth universal dimension for computer-generated time, t. For every tick of time t, the 3D graphics engine regenerates the satellite at its new location and orientation as it orbits the spinning earth. Therefore, a key job for a 3D graphics engine is to continuously synchronize and regenerate all 3D objects within all four computer-generated dimensions x, y, z, and t.

FIG. 5 is a conceptual illustration of what happens inside the computer when an end-user is playing, i.e. running, a first-person 3D application. First-person means that the computer monitor is much like a window, through which the person playing the game views the computer-generated world. To generate this view, the 3D graphics engine renders the scene from the point of view of the eye of a computer-generated person. The computer-generated person can be thought of as a computer-generated or “virtual” simulation of the “real” person actually playing the game.

While running a 3D application the real person, i.e. the end-user, views only a small segment of the entire 3D world at any given time. This is done because it is computationally expensive for the computer's hardware to generate the enormous number of 3D objects in a typical 3D application, the majority of which the end-user is not currently focused on. Therefore, a critical job for the 3D graphics engine is to minimize the computer hardware's computational burden by drawing/rendering as little information as absolutely necessary during each tick of computer-generated time t.

The boxed-in area in FIG. 5 conceptually represents how a 3D graphics engine minimizes the hardware's burden. It focuses computational resources on extremely small areas of information as compared to the 3D applications entire world. In this example, it is a “computer-generated” polar bear cub being observed by a “computer-generated” virtual person 51. Because the end user is running in first-person everything the computer-generated person sees is rendered onto the end-user's monitor, i.e. the end user is looking through the eye of the computer-generated person.

In FIG. 5 the computer-generated person is looking through only one eye; in other words, an one-eyed view 52. This is because the 3D graphics engine's renderer uses central perspective to draw/render 3D objects onto a 2D surface, which requires viewing through only one eye. The area that the computer-generated person sees with a one-eye view is called the “view volume” 53, and the computer-generated 3D objects within this view volume are what actually get rendered to the computer monitor's 2D viewing surface.

FIG. 6 illustrates a view volume 64 in more detail. A view volume is a subset of a “camera model”. A camera model is a blueprint that defines the characteristics of both the hardware and software of a 3D graphics engine. Like a very complex and sophisticated automobile engine, a 3D graphics engine consist of so many parts that their camera models are often simplified to illustrate only the essential elements being referenced.

The camera model depicted in FIG. 6 shows a 3D graphics engine using central perspective to render computer-generated 3D objects to a computer monitor's vertical, 2D viewing surface. The view volume shown in FIG. 6, although more detailed, is the same view volume represented in FIG. 5. The only difference is semantics because a 3D graphics engine calls the computer-generated person's one-eye view a camera point 61 (hence camera model). The camera model uses a camera's line of sight 62, which is typically perpendicular to the projection plane 63.

Every component of a camera model is called an “element”. In our simplified camera model, the projection plane 63, also called near clip plane, is the 2D plane onto which the x, y, z coordinates of the 3D objects within the view volume will be rendered. Each projection line starts at the camera point 61, and ends at a x, y, z coordinate point 65 of a virtual 3D object within the view volume. The 3D graphics engine then determines where the projection line intersects the near clip-plane 63 and the x and y point 66 where this intersection occurs is rendered onto the near clip-plane. Once the 3D graphics engine's renderer completes all necessary mathematical projections, the near clip plane is displayed on the 2D viewing surface of the computer monitor, as shown in the bottom of FIG. 6. A real person's eye 68 can then view 3D image through a real person's line of sight 67, which is the same as the camera's light of sight 62.

The basic of prior art 3D computer graphics is the central perspective projection. 3D central perspective projection, though offering realistic 3D illusion, has some limitations is allowing the user to have hands-on interaction with the 3D display.

There is a little known class of images that we called it “horizontal perspective” where the image appears distorted when viewing head on, but displaying a three dimensional illusion when viewing from the correct viewing position. In horizontal perspective, the angle between the viewing surface and the line of vision is preferably 45° but can be almost any angle, and the viewing surface is preferably horizontal (wherein the name “horizontal perspective”), but it can be any surface, as long as the line of vision forming a not-perpendicular angle to it.

Horizontal perspective images offer realistic three dimensional illusion, but are little known primarily due to the narrow viewing location (the viewer's eyepoint has to be coincide precisely with the image projection eyepoint), and the complexity involving in projecting the two dimensional image or the three dimension model into the horizontal perspective image.

The generation of horizontal perspective images requires considerably more expertise to create than conventional perpendicular images. The conventional perpendicular images can be produced directly from the viewer or camera point. One need simply open one's eyes or point the camera in any direction to obtain the images. Further, with much experience in viewing three dimensional depth cues from perpendicular images, viewers can tolerate significant amount of distortion generated by the deviations from the camera point. In contrast, the creation of a horizontal perspective image does require much manipulation. Conventional camera, by projecting the image into the plane perpendicular to the line of sight, would not produce a horizontal perspective image. Making a horizontal drawing requires much effort and very time consuming. Further, since human has limited experience with horizontal perspective images, the viewer's eye must be positioned precisely where the projection eyepoint point is to avoid image distortion. And therefore horizontal perspective, with its difficulties, has received little attention.

### SUMMARY OF THE INVENTION

The present invention recognizes that the personal computer is perfectly suitable for horizontal perspective display. It is personal, thus it is designed for the operation of one person, and the computer, with its powerful microprocessor, is well capable of rendering various horizontal perspective images to the viewer. Further, horizontal perspective offers open space display of 3D images, thus allowing the hands-on interaction of the end users.

Thus the present invention discloses a hands-on simulator system using 3-D horizontal perspective display. The hands-on simulator system comprises a real time electronic display that can project horizontal perspective images into the open space and a peripheral device that allow the end user to manipulate the images with hands or hand-held tools. Since the horizontal perspective image is projected onto the open space, the user can “touch” the image for a realistic hands-on simulation. The touching action is actually a virtually touching, meaning there is no hand-feeling of touching, only eye-feeling of touching. This virtual touching also enables the user to touch the inside of an object.

The hands-on simulator preferably comprises a computer unit to change the displayed images. The computer unit also keeps track of the peripheral device to ensure synchronization between the peripheral device and the displayed image. The system can further include a calibration unit to ensure the proper mapping of the peripheral device to the display images.

The hands-on simulator preferably comprises an eyepoint tracking unit to re-calculate the horizontal perspective image using the user's eyepoint as the projection point for minimizing distortion. The hands-on simulator further comprises a means to manipulate the displayed image such as magnification, zoom, rotation, movement, and even display a new image.

### BRIEF DESCRIPTION OF THE DRAWINGS

FIG. 1 shows the various perspective drawings.

FIG. 2 shows a typical central perspective drawing.

FIG. 3 shows a schematic of 3D software development.

FIG. 4 shows a computer world view.

FIG. 5 shows a virtual world inside a computer.

FIG. 6 shows a 3D central perspective display scheme.

FIG. 7 shows the comparison of central perspective (Image A) and horizontal perspective (Image B).

FIG. 8 shows the central perspective drawing of three stacking blocks.

FIG. 9 shows the horizontal perspective drawing of three stacking blocks.

FIG. 10 shows the method of drawing a horizontal perspective drawing.

FIG. 11 shows the incorrect mapping of a 3-d object onto the horizontal plane.

FIG. 12 shows the correct mapping of a 3-d object onto the horizontal plane.

FIG. 13 shows a typical planar viewing surface with a z-axis correction.

FIG. 14 shows a 3D horizontal perspective image of FIG. 13.

FIG. 15 shows an embodiment of the present invention hands-on simulator.

FIG. 16 shows a time simulation of the present invention hands-on simulator.

FIG. 17 shows some typical hand-held peripheral devices.

FIG. 18 shows the mapping of a peripheral device onto the hands-on volume.

FIG. 19 shows an user using the present invention hands-on simulator.

FIG. 20 shows an hands-on simulator with cameras triangulation.

FIG. 21 shows an Hands-on simulator with cameras and speakers triangulation.

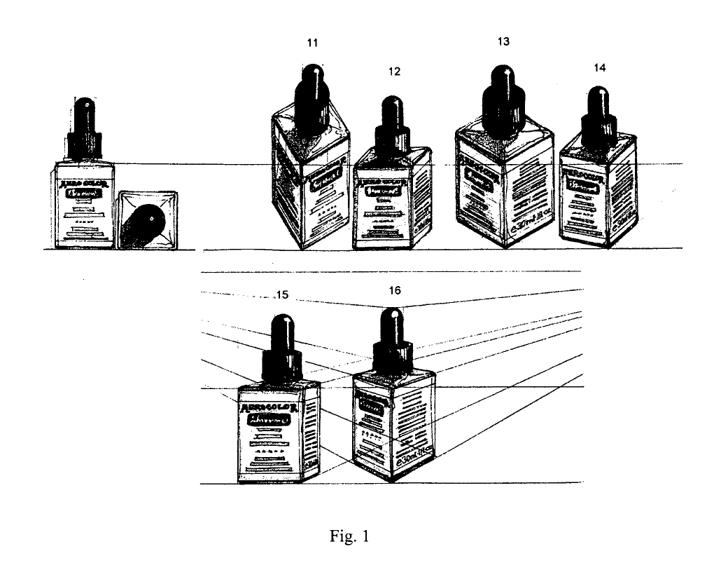

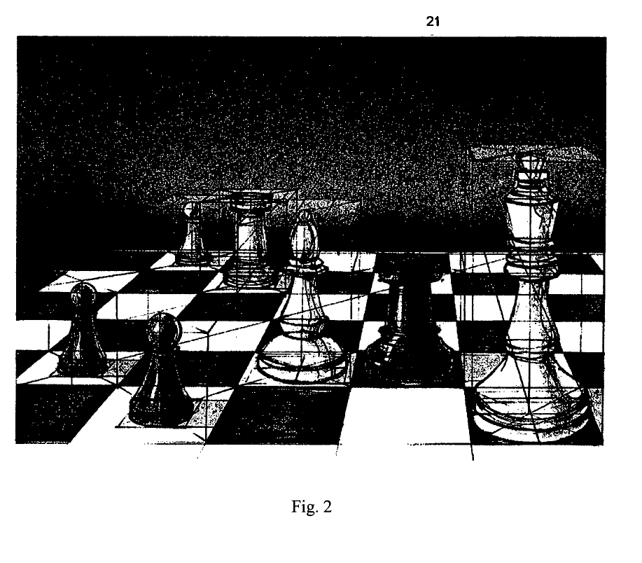

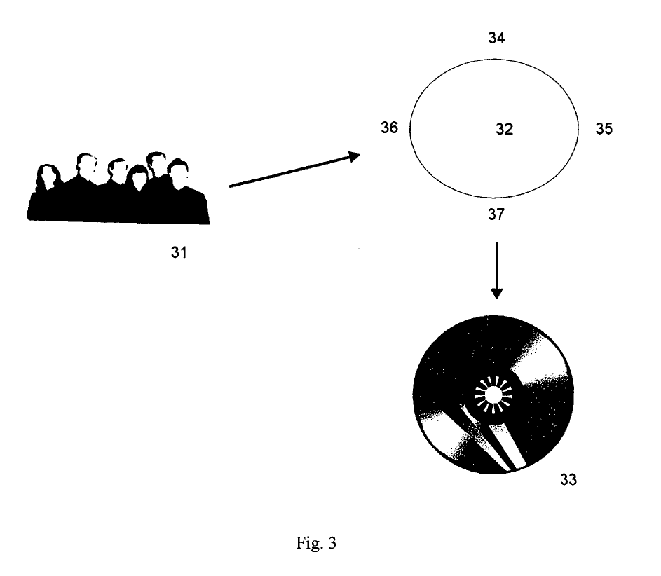

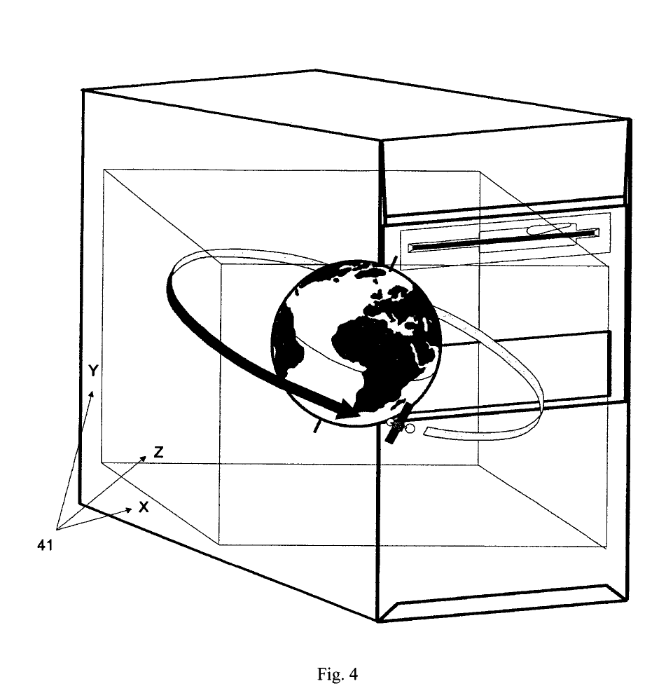

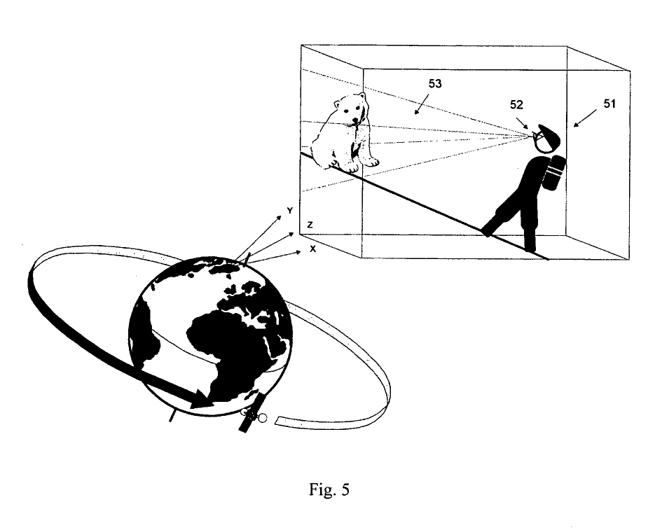

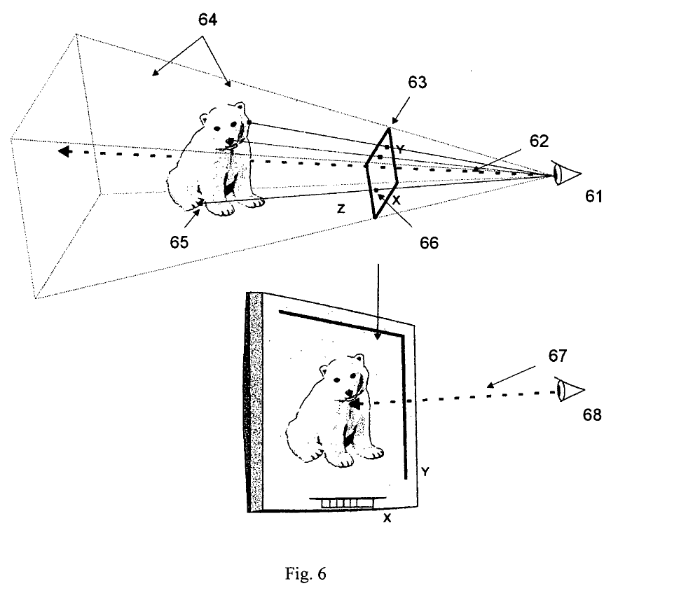

### DETAILED DESCRIPTION OF THE INVENTION

The new and unique inventions described in this document build upon prior art by taking the current state of real-time computer-generated 3D computer graphics, 3D sound, and tactile computer-human interfaces to a whole new level of reality and simplicity. More specifically, these new inventions enable real-time computer-generated 3D simulations to coexist in physical space and time with the end-user and with other real-world physical objects. This capability dramatically improves upon the end-user's visual, auditory and tactile computing experience by providing direct physical interactions with 3D computer-generated objects and sounds. This unique ability is useful in nearly every conceivable industry including, but not limited to, electronics, computers, biometrics, medical, education, games, movies, science, legal, financial, communication, law enforcement, national security, military, print media, television, advertising, trade show, data visualization, computer-generated reality, animation, CAD/CAE/CAM, productivity software, operating systems, and more.

The present invention horizontal perspective hands-on simulator is build upon the horizontal perspective system capable of projecting three dimensional illusions based on horizontal perspective projection.

Horizontal perspective is a little-known perspective, of which we found only two books that describe its mechanics: Stereoscopic Drawing (©1990) and How to Make Anaglyphs (©1979, out of print). Although these books describe this obscure perspective, they do not agree on its name. The first book refers to it as a “free-standing anaglyph,” and the second, a “phantogram.” Another publication called it “projective anaglyph” (U.S. Pat. No. 5,795,154 by G. M. Woods, Aug. 18, 1998). Since there is no agreed-upon name, we have taken the liberty of calling it “horizontal perspective.” Normally, as in central perspective, the plane of vision, at right angle to the line of sight, is also the projected plane of the picture, and depth cues are used to give the illusion of depth to this flat image. In horizontal perspective, the plane of vision remains the same, but the projected image is not on this plane. It is on a plane angled to the plane of vision. Typically, the image would be on the ground level surface. This means the image will be physically in the third dimension relative to the plane of vision. Thus horizontal perspective can be called horizontal projection.

In horizontal perspective, the object is to separate the image from the paper, and fuse the image to the three dimension object that projects the horizontal perspective image. Thus the horizontal perspective image must be distorted so that the visual image fuses to form the free standing three dimensional figure. It is also essential the image is viewed from the correct eye points, otherwise the three dimensional illusion is lost. In contrast to central perspective images which have height and width, and project an illusion of depth, and therefore the objects are usually abruptly projected and the images appear to be in layers, the horizontal perspective images have actual depth and width, and illusion gives them height, and therefore there is usually a graduated shifting so the images appear to be continuous.

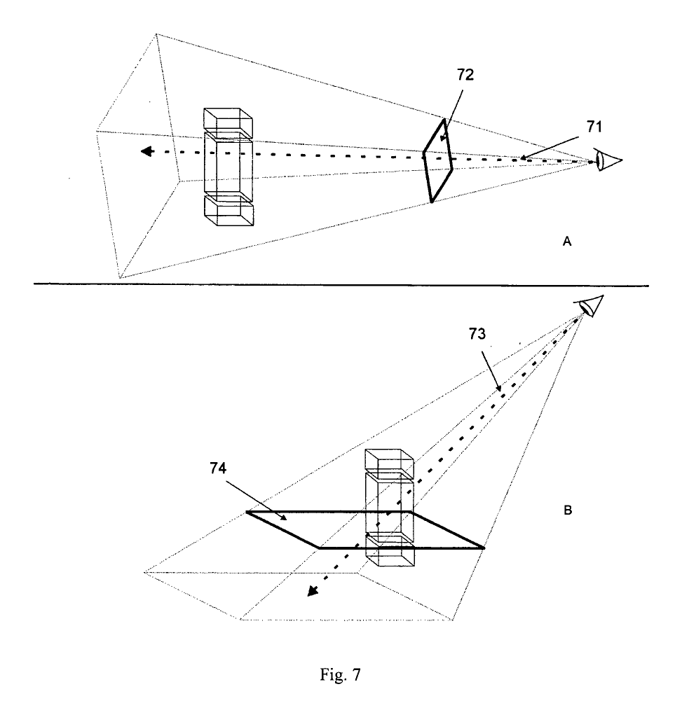

FIG. 7 compares key characteristics that differentiate central perspective and horizontal perspective. Image A shows key pertinent characteristics of central perspective, and Image B shows key pertinent characteristics of horizontal perspective. In other words, in Image A, the real-life three dimension object (three blocks stacked slightly above each other) was drawn by the artist closing one eye, and viewing along a line of sight 71 perpendicular to the vertical drawing plane 72. The resulting image, when viewed vertically, straight on, and through one eye, looks the same as the original image.

In Image B, the real-life three dimension object was drawn by the artist closing one eye, and viewing along a line of sight 73 45° to the horizontal drawing plane 74. The resulting image, when viewed horizontally, at 45° and through one eye, looks the same as the original image.

One major difference between central perspective showing in Image A and horizontal perspective showing in Image B is the location of the display plane with respect to the projected three dimensional image. In horizontal perspective of Image B, the display plane can be adjusted up and down, and therefore the projected image can be displayed in the open air above the display plane, i.e. a physical hand can touch (or more likely pass through) the illusion, or it can be displayed under the display plane, i.e. one cannot touch the illusion because the display plane physically blocks the hand. This is the nature of horizontal perspective, and as long as the camera eyepoint and the viewer eyepoint is at the same place, the illusion is present. In contrast, in central perspective of Image A, the three dimensional illusion is likely to be only inside the display plane, meaning one cannot touch it. To bring the three dimensional illusion outside of the display plane to allow viewer to touch it, the central perspective would need elaborate display scheme such as surround image projection and large volume.

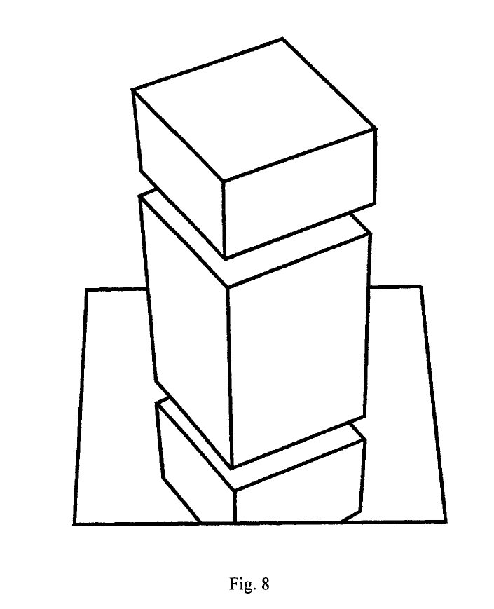

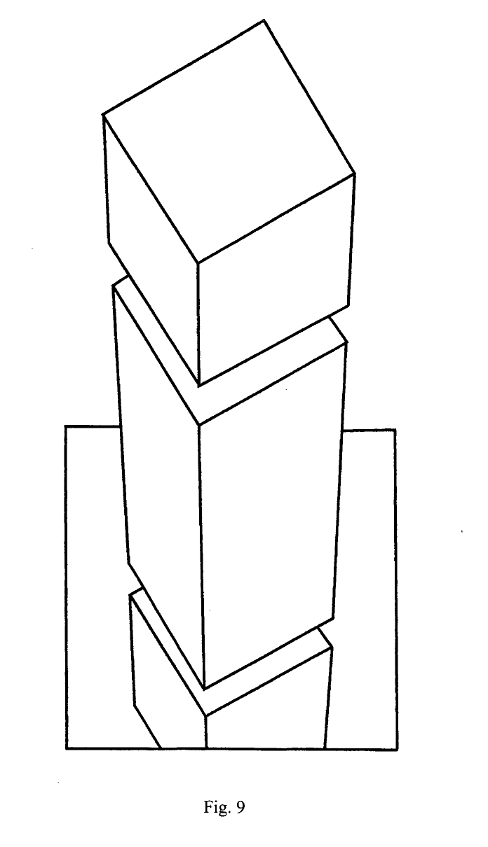

FIGS. 8 and 9 illustrate the visual difference between using central and horizontal perspective. To experience this visual difference, first look at FIG. 8, drawn with central perspective, through one open eye. Hold the piece of paper vertically in front of you, as you would a traditional drawing, perpendicular to your eye. You can see that central perspective provides a good representation of three dimension objects on a two dimension surface.

Now look at FIG. 9, drawn using horizontal perspective, by sifting at your desk and placing the paper lying flat (horizontally) on the desk in front of you. Again, view the image through only one eye. This puts your one open eye, called the eye point at approximately a 45° angle to the paper, which is the angle that the artist used to make the drawing. To get your open eye and its line-of-sight to coincide with the artist's, move your eye downward and forward closer to the drawing, about six inches out and down and at a 45° angle. This will result in the ideal viewing experience where the top and middle blocks will appear above the paper in open space.

Again, the reason your one open eye needs to be at this precise location is because both central and horizontal perspective not only defines the angle of the line of sight from the eye point; they also define the distance from the eye point to the drawing. This means that FIGS. 8 and 9 are drawn with an ideal location and direction for your open eye relative to the drawing surfaces. However, unlike central perspective where deviations from position and direction of the eye point create little distortion, when viewing a horizontal perspective drawing, the use of only one eye and the position and direction of that eye relative to the viewing surface are essential to seeing the open space three dimension horizontal perspective illusion.

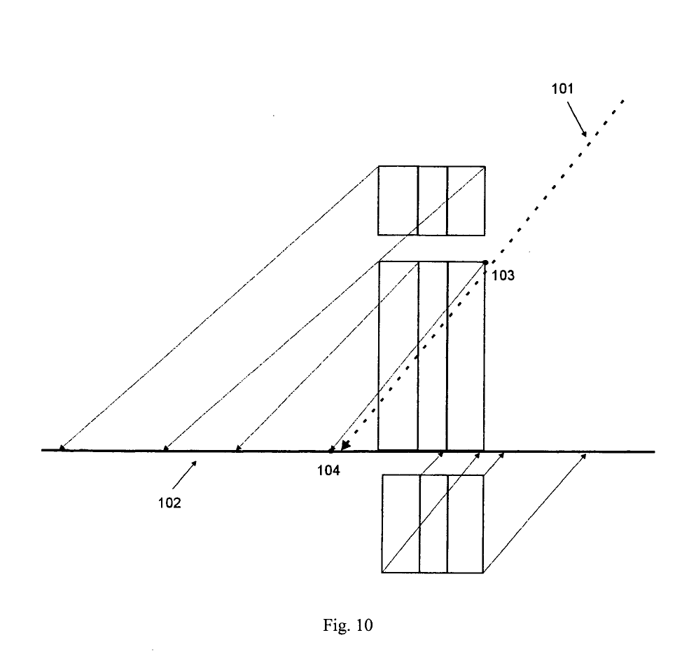

FIG. 10 is an architectural-style illustration that demonstrates a method for making simple geometric drawings on paper or canvas utilizing horizontal perspective. FIG. 10 is a side view of the same three blocks used in FIGS. 9. It illustrates the actual mechanics of horizontal perspective. Each point that makes up the object is drawn by projecting the point onto the horizontal drawing plane. To illustrate this, FIG. 10 shows a few of the coordinates of the blocks being drawn on the horizontal drawing plane through projection lines. These projection lines start at the eye point (not shown in FIG. 10 due to scale), intersect a point 103 on the object, then continue in a straight line to where they intersect the horizontal drawing plane 102, which is where they are physically drawn as a single dot 104 on the paper. When an architect repeats this process for each and every point on the blocks, as seen from the drawing surface to the eye point along the line-of-sight 101 the horizontal perspective drawing is complete, and looks like FIG. 9.

Notice that in FIG. 10, one of the three blocks appears below the horizontal drawing plane. With horizontal perspective, points located below the drawing surface are also drawn onto the horizontal drawing plane, as seen from the eye point along the line-of-site. Therefore when the final drawing is viewed, objects not only appear above the horizontal drawing plane, but may also appear below it as well-giving the appearance that they are receding into the paper. If you look again at FIG. 9, you will notice that the bottom box appears to be below, or go into, the paper, while the other two boxes appear above the paper in open space.

The generation of horizontal perspective images requires considerably more expertise to create than central perspective images. Even though both methods seek to provide the viewer the three dimension illusion that resulted from the two dimensional image, central perspective images produce directly the three dimensional landscape from the viewer or camera point. In contrast, the horizontal perspective image appears distorted when viewing head on, but this distortion has to be precisely rendered so that when viewing at a precise location, the horizontal perspective produces a three dimensional illusion.

The horizontal perspective display system promotes horizontal perspective projection viewing by providing the viewer with the means to adjust the displayed images to maximize the illusion viewing experience. By employing the computation power of the microprocessor and a real time display, the horizontal perspective display, comprising a real time electronic display capable of re-drawing the projected image, together with a viewer's input device to adjust the horizontal perspective image. By re-display the horizontal perspective image so that its projection eyepoint coincides with the eyepoint of the viewer, the horizontal perspective display of the present invention can ensure the minimum distortion in rendering the three dimension illusion from the horizontal perspective method. The input device can be manually operated where the viewer manually inputs his or her eyepoint location, or change the projection image eyepoint to obtain the optimum three dimensional illusions. The input device can also be automatically operated where the display automatically tracks the viewer's eyepoint and adjust the projection image accordingly. The horizontal perspective display system removes the constraint that the viewers keeping their heads in relatively fixed positions, a constraint that create much difficulty in the acceptance of precise eyepoint location such as horizontal perspective or hologram display.

The horizontal perspective display system can further include a computation device in addition to the real time electronic display device and projection image input device providing input to the computational device to calculating the projectional images for display to providing a realistic, minimum distortion three dimensional illusion to the viewer by coincide the viewer's eyepoint with the projection image eyepoint. The system can further comprise an image enlargement/reduction input device, or an image rotation input device, or an image movement device to allow the viewer to adjust the view of the projection images.

The input device can be operated manually or automatically. The input device can detect the position and orientation of the viewer eyepoint, to compute and to project the image onto the display according to the detection result. Alternatively, the input device can be made to detect the position and orientation of the viewer's head along with the orientation of the eyeballs. The input device can comprise an infrared detection system to detect the position the viewer's head to allow the viewer freedom of head movement. Other embodiments of the input device can be the triangulation method of detecting the viewer eyepoint location, such as a CCD camera providing position data suitable for the head tracking objectives of the invention. The input device can be manually operated by the viewer, such as a keyboard, mouse, trackball, joystick, or the like, to indicate the correct display of the horizontal perspective display images.

The invention described in this document, employing the open space characteristics of the horizontal perspective, together with a number of new computer hardware and software elements and processes that together to create a “Hands-On Simulator”. In the simplest terms, the Hands-On Simulator generates a totally new unique computing experience in that it enables an end user to interact physically and directly (Hands-On) with real-time computer-generated 3D graphics (Simulations), which appear in open space above the viewing surface of a display device, i.e. in the end user's own physical space.

For the end user to experience these unique hands-on simulations the computer hardware viewing surface is situated horizontally, such that the end-user's line of sight is at a 45° angle to the surface. Typically, this means that the end user is standing or seated vertically, and the viewing surface is horizontal to the ground. Note that although the end user can experience hands-on simulations at viewing angles other than 45° (e.g. 55°, 30° etc.), it is the optimal angle for the brain to recognize the maximum amount of spatial information in an open space image. Therefore, for simplicity's sake, we use “45°” throughout this document to mean “an approximate 45 degree angle”. Further, while horizontal viewing surface is preferred since it simulates viewers' experience with the horizontal ground, any viewing surface could offer similar three dimensional illusion experience. The horizontal perspective illusion can appear to be hanging from a ceiling by projecting the horizontal perspective images onto a ceiling surface, or appear to be floating from a wall by projecting the horizontal perspective images onto a vertical wall surface.

The hands-on simulations are generated within a 3D graphics engines' view volume, creating two new elements, the “Hands-On Volume” and the “Inner-Access Volume.” The Hands-On Volume is situated on and above the physical viewing surface. Thus the end user can directly, physically manipulate simulations because they co-inhabit the end-user's own physical space. This 1:1 correspondence allows accurate and tangible physical interaction by touching and manipulating simulations with hands or hand-held tools. The Inner-Access Volume is located underneath the viewing surface and simulations within this volume appear inside the physically viewing device. Thus simulations generated within the Inner-Access Volume do not share the same physical space with the end user and the images therefore cannot be directly, physically manipulated by hands or hand-held tools. That is, they are manipulated indirectly via a computer mouse or a joystick.

This disclosed Hands-On Simulator can lead to the end user's ability to directly, physically manipulate simulations because they co-inhabit the end-user's own physical space. To accomplish this requires a new computing concept where computer-generated world elements have a 1:1 correspondence with their physical real-world equivalents; that is, a physical element and an equivalent computer-generated element occupy the same space and time. This is achieved by identifying and establishing a common “Reference Plane”, to which the new elements are synchronized.

Synchronization with the Reference Plane forms the basis to create the 1:1 correspondence between the “virtual” world of the simulations, and the “real” physical world. Among other things, the 1:1 correspondence insures that images are properly displayed: What is on and above the viewing surface appears on and above the surface, in the Hands-On Volume; what is underneath the viewing surface appears below, in the Inner-Access Volume. Only if this 1:1 correspondence and synchronization to the Reference Plane are present can the end user physically and directly access and interact with simulations via their hands or hand-held tools.

The present invention simulator further includes a real-time computer-generated 3D-graphics engine as generally described above, but using horizontal perspective projection to display the 3D images. One major different between the present invention and prior art graphics engine is the projection display. Existing 3D-graphics engine uses central-perspective and therefore a vertical plane to render its view volume while in the present invention simulator, a “horizontal” oriented rendering plane vs. a “vertical” oriented rendering plane is required to generate horizontal perspective open space images. The horizontal perspective images offer much superior open space access than central perspective images.

One of the invented elements in the present invention hands-on simulator is the 1:1 correspondence of the computer-generated world elements and their physical real-world equivalents. As noted in the introduction above, this 1:1 correspondence is a new computing concept that is essential for the end user to physically and directly access and interact with hands-on simulations. This new concept requires the creation of a common physical Reference Plane, as well as, the formula for deriving its unique x, y, z spatial coordinates. To determine the location and size of the Reference Plane and its specific coordinates requires understanding the following.

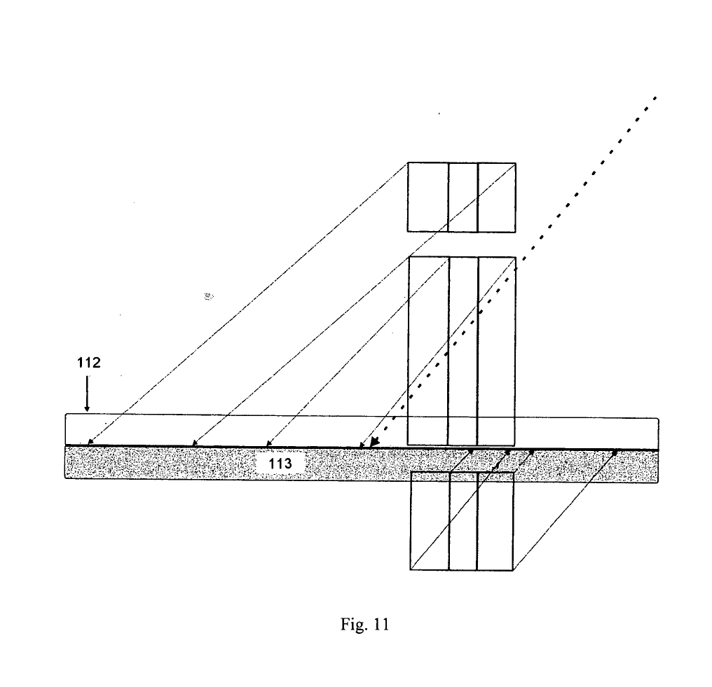

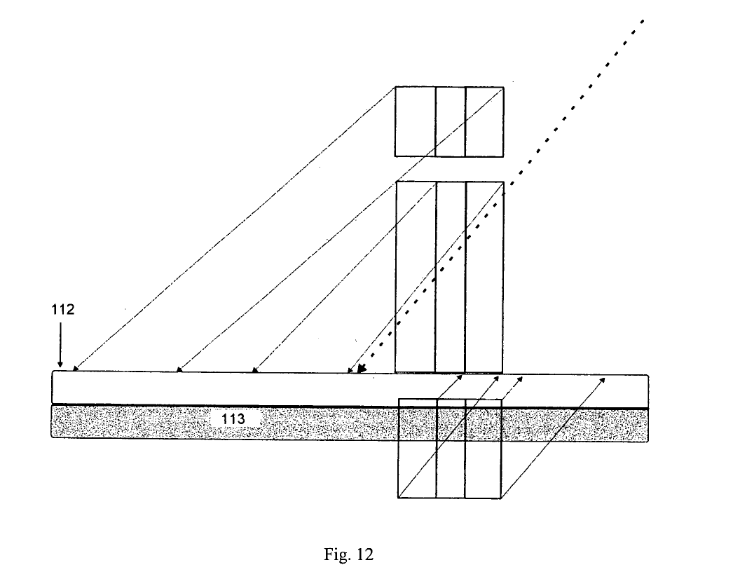

A computer monitor or viewing device is made of many physical layers, individually and together having thickness or depth. To illustrate this, FIGS. 11 and 12 contain a conceptual side-view of typical CRT-type viewing device. The top layer of the monitor's glass surface is the physical “View Surface” 112, and the phosphor layer, where images are made, is the physical “Image Layer” 113. The View Surface 112 and the Image Layer 113 are separate physical layers located at different depths or z coordinates along the viewing device's z axis. To display an image the CRT's electron gun excites the phosphors, which in turn emit photons. This means that when you view an image on a CRT, you are looking along its z axis through its glass surface, like you would a window, and seeing the light of the image coming from its phosphors behind the glass.

With a viewing device's z axis in mind, let's display an image on that device using horizontal perspective. In FIGS. 111 and 12, we use the same architectural technique for drawing images with horizontal perspective as previously illustrated in FIG. 10. By comparing FIG. 11 and FIG. 10 you can see that the middle block in FIG. 11 does not correctly appear on the View Surface 112. In FIG. 10 the bottom of the middle block is located correctly on the horizontal drawing/viewing plane, i.e. a piece of paper's View Surface. But in FIG. 11, the phosphor layer, i.e. where the image is made, is located behind the CRT's glass surface. Therefore, the bottom of the middle block is incorrectly positioned behind or underneath the View Surface.

FIG. 12 shows the proper location of the three blocks on a CRT-type viewing device. That is, the bottom of the middle block is displayed correctly on the View Surface 112 and not on the Image Layer 113. To make this adjustment the z coordinates of the View Surface and Image Layer are used by the Simulation Engine to correctly render the image. Thus the unique task of correctly rendering an open space image on the View Surface vs. the Image Layer is critical in accurately mapping the simulation images to the real world space.

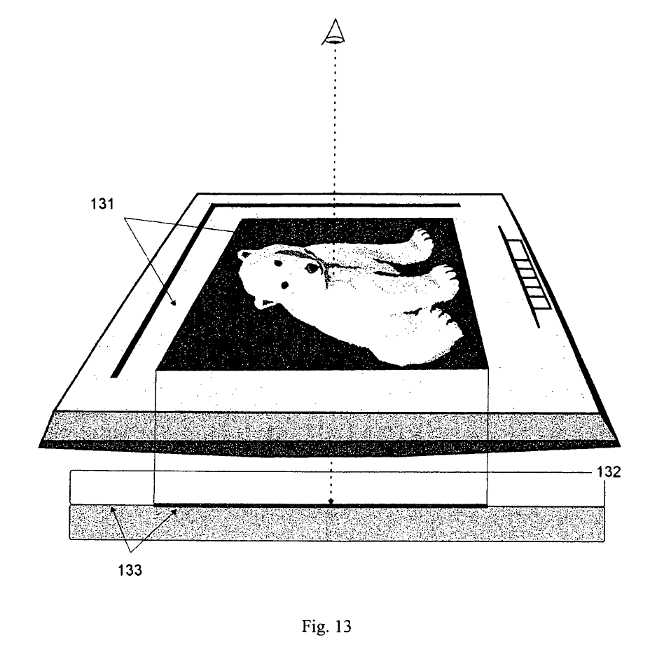

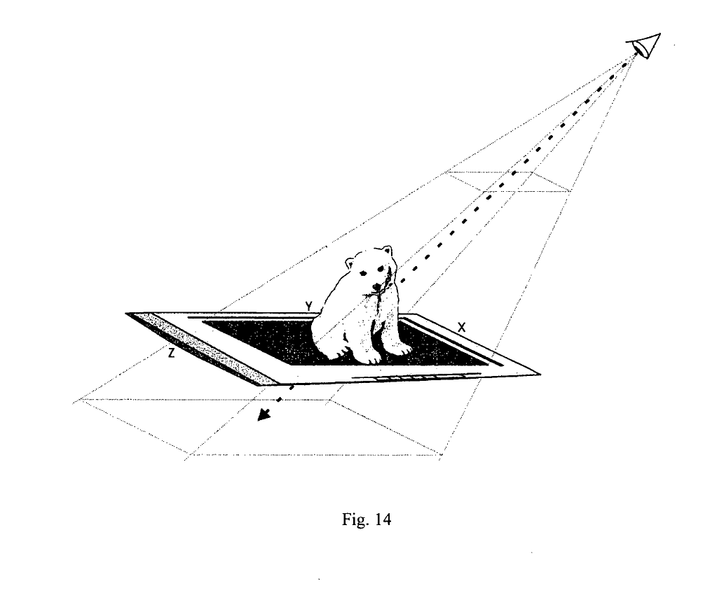

It is now clear that a viewing device's View Surface is the correct physical location to present open space images. Therefore, as shown in FIG. 13, the View Surface 131, i.e. the top of the viewing device's glass surface, is the common physical Reference Plane. But only a subset of the View Surface can be the Reference Plane because the entire View Surface is larger than the total image area. FIG. 13 shows an example of a complete image being displayed on a viewing device's View Surface. That is, the image, including the bear cub, shows the entire image area, which is smaller than the viewing device's View Surface. Looking straight at the image, a flat image can be seen as in FIG. 13, but looking at a proper angle, a 3D horizontal perspective image can emerged as shown in FIG. 14.

Many viewing devices enable the end user to adjust the size of the image area by adjusting its x and y value. Of course these same viewing devices do not provide any knowledge of, or access to, the z axis information because it is a completely new concept and to date only required for the display of open space images. But all three, x, y, z, coordinates are essential to determine the location and size of the common physical Reference Plane. The formula for this is: The Image Layer 133 is given a z coordinate of 0. The View Surface is the distance along the z axis from the Image Layer the Reference Plane's z coordinate 132 is equal to the View Surface, i.e. its distance from the Image Layer. The x and y coordinates, or size of the Reference Plane, can be determined by displaying a complete image on the viewing device and measuring the length of its x and y axis.

The concept of the common physical Reference Plane is a new inventive concept. Therefore, display manufactures may not supply or even know its coordinates. Thus a “Reference Plane Calibration” procedure might need to be performed to establish the Reference Plane coordinates. This calibration procedure provides the end user with a number of orchestrated images that s/he interacts. The end-user's response to these images provides feedback to the Simulation Engine such that it can identify the correct size and location of the Reference Plane. When the end user is satisfied and completes the procedure the coordinates are saved in the end user's personal profile.

With some viewing devices the distance between the View Surface and Image Layer is quite short. But no matter how small or large the distance, it is critical that all Reference Plane x, y, and z coordinates are determined as close as technically possible.

After the mapping of the “computer-generated” horizontal perspective projection display plane (Horizontal Plane) to the “physical” Reference Plane x, y, z coordinates, the two elements coexist and are coincident in time and space; that is, the computer-generated Horizontal Plane now shares the real-world x, y, z coordinates of the physical Reference Plane, and they exist at the same time.

You can envision this unique mapping of a computer-generated element and a physical element occupying the same space and time by imagining you are sitting in front of a horizontally oriented computer monitor and using the Hands-On Simulator. By placing your finger on the surface of the monitor, you would touch the Reference Plane (a portion of the physical View Surface) and the Horizontal Plane (computer-generated) at exactly the same time, In other words, when touching the physical surface of the monitor, you are also “touching” its computer-generated equivalent, the Horizontal Plane, which has been created and mapped by the Simulation Engine to the same location and time.

One element of the present invention horizontal perspective projection hands-on simulator is a computer-generated “Angled Camera” point. The camera point is initially located at an arbitrary distance from the Horizontal Plane and the camera's line-of-site is oriented at a 45° angle looking through the center. The position of the Angled Camera in relation to the end-user's eye is critical to generating simulations that appear in open space on and above the surface of the viewing device.

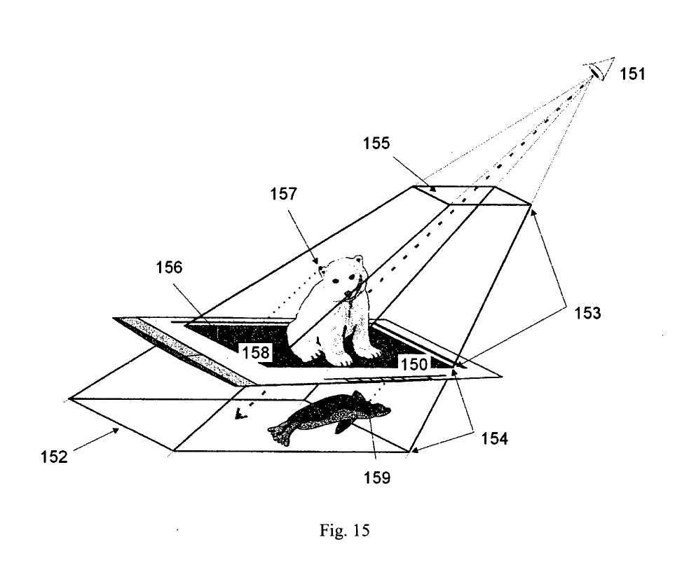

Mathematically, the computer-generated x, y, z coordinates of the Angled Camera point form the vertex of an infinite “pyramid”, whose sides pass through the x, y, z coordinates of the Reference/Horizontal Plane. FIG. 15 illustrates this infinite pyramid, which begins at the Angled Camera point 151 and extending through the Far Clip Plane (not shown). There are new planes within the pyramid that run parallel to the Reference/Horizontal Plane 156, which, together with the sides of the pyramid define two new view volumes. These unique view volumes are called Hands-On Volume 153 and the Inner-Access Volume 154. The dimensions of these volumes and the planes that define them are based on their locations within the pyramid.

FIG. 15 also illustrates a plane 155, called Comfort Plane, together with other display elements. The Comfort Plane is one of six planes that define the Hands-On Volume 153, and of these planes it is closest to the Angled Camera point 151 and parallel to the Reference Plane 156. The Comfort Plane 155 is appropriately named because its location within the pyramid determines the end-user's personal comfort, i.e. how their eyes, head, body, etc. are situated while viewing and interacting with simulations. The end user can adjust the location of the Comfort Plane based on their personal visual comfort through a “Comfort Plane Adjustment” procedure. This procedure provides the end user with orchestrated simulations within the Hands-On Volume, and enables them to adjust the location of the Comfort Plane within the pyramid relative to the Reference Plane. When the end user is satisfied and completes the procedure the location of the Comfort Plane is saved in the end-user's personal profiles.

The present invention simulator uniquely defines a “Hands-On Volume” 153. The Hands-On Volume is where you can reach your hand in and physically “touch” a simulation. You can envision this by imagining you are sifting in front of a horizontally oriented computer monitor and using the Hands-On Simulator. If you place your hand several inches above the surface of the monitor, you are putting your hand inside both the physical and computer-generated Hands-On Volume at the same time. The Hands-On Volume exists within the pyramid and are between and inclusive of the Comfort Planes and the Reference/Horizontal Planes.

Where the Hands-On Volume exists on and above the Reference/Horizontal Plane, the present simulator also optionally defines an Inner-Access Volume 154 existing below or inside the physical viewing device. For this reason, an end user cannot directly interact with 3D objects located within the Inner-Access Volume via their hand or hand-held tools. But they can interact in the traditional sense with a computer mouse, joystick, or other similar computer peripheral. An “Inner Plane” is further defined, located immediately below and are parallel to the Reference/Horizontal Plane 156 within the pyramid. For practical reasons, these two planes can be said to be the same. The Inner Plane, along with the Bottom Plane 152, is two of the six planes within the pyramid that define the Inner-Access Volume. The Bottom Plane 152 is farthest away from the Angled Camera point, but it is not to be mistaken for the Far Clip plane. The Bottom Plane is also parallel to the Reference/Horizontal Plane and is one of the six planes that define the Inner-Access Volume. You can envision the Inner-Access Volume by imagining you are sitting in front of a horizontally oriented computer monitor and using the Hands-On Simulator. If you pushed your hand through the physical surface and placed your hand inside the monitor (which of course is not possible), you would be putting your hand inside the Inner-Access Volume.

The end-user's preferred viewing distance to the bottom of the viewing pyramid determines the location of these planes. One way the end user can adjust the location of the Bottom Planes is through a “Bottom Plane Adjustment” procedure. This procedure provides the end user with orchestrated simulations within the Inner-Access Volume and enables them to interact and adjust the location of the Bottom Plane relative to the physical Reference/Horizontal Plane. When the end user completes the procedure the Bottom Plane's coordinates are saved in the end-user's personal profiles.

For the end user to view open space images on their physical viewing device it must be positioned properly, which usually means the physical Reference Plane is placed horizontally to the ground. Whatever the viewing device's position relative to the ground, the Reference/Horizontal Plane must be at approximately a 45° angle to the end-user's line-of-sight for optimum viewing. One way the end user might perform this step is to position their CRT computer monitor on the floor in a stand, so that the Reference/Horizontal Plane is horizontal to the floor. This example use a CRT-type computer monitor, but it could be any type of viewing device, placed at approximately a 45° angle to the end-user's line-of-sight.

The real-world coordinates of the “End-User's Eye” and the computer-generated Angled Camera point must have a 1:1 correspondence in order for the end user to properly view open space images that appear on and above the Reference/Horizontal Plane. One way to do this is for the end user to supply the Simulation Engine with their eye's real-world x, y, z location and line-of-site information relative to the center of the physical Reference/Horizontal Plane. For example, the end user tells the Simulation Engine that their physical eye will be located 12 inches up, and 12 inches back, while looking at the center of the Reference/Horizontal Plane. The Simulation Engine then maps the computer-generated Angled Camera point to the End-User's Eye point physical coordinates and line-of-sight.

The present invention horizontal perspective hands-on simulator employs the horizontal perspective projection to mathematically projected the 3D objects to the Hands-On and Inner-Access Volumes. The existence of a physical Reference Plane and the knowledge of its coordinates are essential to correctly adjusting the Horizontal Plane's coordinates prior to projection. This adjustment to the Horizontal Plane enables open space images to appear to the end user on the View Surface vs. the Image Layer by taking into account the offset between the Image Layer and the View Surface, which are located at different values along the viewing device's z axis.

As a projection line in either the Hands-On and Inner-Access Volume intersects both an object point and the offset Horizontal Plane, the three dimensional x, y, z point of the object becomes a two-dimensional x, y point of the Horizontal Plane. Projection lines often intersect more than one 3D object coordinate, but only one object x, y, z coordinate along a given projection line can become a Horizontal Plane x, y point. The formula to determine which object coordinate becomes a point on the Horizontal Plane is different for each volume. For the Hands-On Volume, an object coordinate 157 results in an image coordination 158 by following a given projection line that is farthest from the Horizontal Plane. For the Inner-Access Volume, an object coordinate 159 results in an image coordination 150 by following a given projection line that is closest to the Horizontal Plane. In case of a tie, i.e. if a 3D object point from each volume occupies the same 2D point of the Horizontal Plane, the Hands-On Volume's 3D object point is used.

FIG. 15 is then an illustration of the present invention Simulation Engine that includes the new computer-generated and real physical elements as described above. It also shows that a real-world element and its computer-generated equivalent are mapped 1:1 and together share a common Reference Plane. The full implementation of this Simulation Engine results in a Hands-On Simulator with real-time computer-generated 3D-graphics appearing in open space on and above a viewing device's surface, which is oriented approximately 45° to the end-user's line-of-sight.

The Hands-On Simulator further involves adding completely new elements and processes and existing stereoscopic 3D computer hardware. The result in a Hands-On Simulator with multiple views or “Multi-View” capability. Multi-View provides the end user with multiple and/or separate left-and right-eye views of the same simulation.

To provide motion, or time-related simulation, the simulator further includes a new computer-generated “time dimension” element, called “SI-time”. SI is an acronym for “Simulation Image” and is one complete image displayed on the viewing device. SI-Time is the amount of time the Simulation Engine uses to completely generate and display one Simulation Image. This is similar to a movie projector where 24 times a second it displays an image. Therefore, 1/24 of a second is required for one image to be displayed by the projector But SI-Time is variable, meaning that depending on the complexity of the view volumes it could take 1/120^{th} or ½ a second for the Simulation Engine to complete just one SI.

The simulator also includes a new computer-generated “time dimension” element, called “EV-time” and is the amount of time used to generate a one “Eye-View”. For example, let's say that the Simulation Engine needs to create one left-eye view and one right-eye view for purposes of providing the end user with a stereoscopic 3D experience. If it takes the Simulation Engine 1/2 a second to generate the left-eye view then the first EV-Time period is 1/2 a second. If it takes another 1/2 second to generate the right-eye view then the second EV-Time period is also ½ second. Since the Simulation Engine was generating a separate left and right eye view of the same Simulation Image the total SI-Time is one second. That is, the first EV-Time was ½ second and the second EV-Time was also ½ second making a total SI-Time of one second.

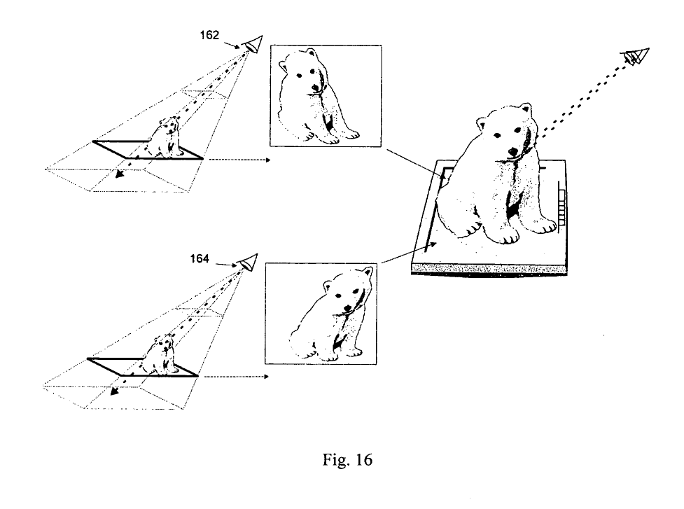

FIG. 16 helps illustrate these two new time dimension elements. It is a conceptual drawing of what is occurring inside the Simulation Engine when it is generating a two-eye view of a Simulated Image. The computer-generated person has both eyes open, a requirement for stereoscopic 3D viewing, and therefore sees the bear cub from two separate vantage points, i.e. from both a right-eye view and a left-eye view. These two separate views are slightly different and offset because the average person's eyes are about 2 inches apart. Therefore, each eye sees the world from a separate point in space and the brain puts them together to make a whole image. This is how and why we see the real world in stereoscopic 3D.

FIG. 16 is a very high-level Simulation Engine blueprint focusing on how the computer-generated person's two eye views are projected onto the Horizontal Plane and then displayed on a stereoscopic 3D capable viewing device, representing one complete SI-Time period. If we use the example from step 3 above, SI-Time takes one second. During this one second of SI-Time the Simulation Engine needs to generate two different eye views, because in this example the stereoscopic 3D viewing device requires a separate left- and right-eye view. There are existing stereoscopic 3D viewing devices that require more than a separate left- and right-eye view. But because the method described here can generate multiple views it works for these devices as well.

The illustration in the upper left of FIG. 16 shows the Angled Camera point for the right eye 162 at time-element “EV-Time-1”, which means the first Eye-View time period or the first eye-view to be generated. So in FIG. 16, EV-Time-1 is the time period used by the Simulation Engine to complete the first eye (right-eye) view of the computer-generated person. This is the job for this step, which is within EV-Time-1, and using the Angled Camera at coordinate x, y, z, the Simulation Engine completes the rendering and display of the right-eye view of a given Simulation Image.

Once the first eye (right-eye) view is complete, the Simulation Engine starts the process of rendering the computer-generated person's second eye (left-eye) view. The illustration in the lower left of FIG. 16 shows the Angled Camera point for the left eye 164 at time element “EV-Time-2”. That is, this second eye view is completed during EV-Time-2. But before the rendering process can begin, step 5 makes an adjustment to the Angled Camera point. This is illustrated in FIG. 16 by the left eye's x coordinate being incremented by two inches. This difference between the right eye's x value and the left eye's x+2″ is what provides the two-inch separation between the eyes, which is required for stereoscopic 3D viewing.

The distances between people's eyes vary but in the above example we are using the average of 2 inches. It is also possible for the end user to supply the Simulation Engine with their personal eye separation value. This would make the x value for the left and right eyes highly accurate for a given end user and thereby improve the quality of their stereoscopic 3D view.

Once the Simulation Engine has incremented the Angled Camera point's x coordinate by two inches, or by the personal eye separation value supplied by the end user, it completes the rendering and display of the second (left-eye) view. This is done by the Simulation Engine within the EV-Time-2 period using the Angled Camera point coordinate x±2″, y, z and the exact same Simulation Image rendered. This completes one SI-Time period.

Depending on the stereoscopic 3D viewing device used, the Simulation Engine continues to display the left- and right-eye images, as described above, until it needs to move to the next SI-Time period. The job of this step is to determine if it is time to move to a new SI-Time period, and if it is, then increment SI-Time. An example of when this may occur is if the bear cub moves his paw or any part of his body Then a new and second Simulated Image would be required to show the bear cub in its new position. This new Simulated Image of the bear cub, in a slightly different location, gets rendered during a new SI-Time period or SI-Time-2. This new SI-time-2 period will have its own EV-Time-1 and EV-Time-2, and therefore the simulation steps described above will be repeated during SI-time-2. This process of generating multiple views via the nonstop incrementing of SI-Time and its EV-Times continues as long as the Simulation Engine is generating real-time simulations in stereoscopic 3D.

The above steps describe new and unique elements and process that makeup the Hands-On Simulator with Multi-View capability. Multi-View provides the end user with multiple and/or separate left- and right-eye views of the same simulation. Multi-View capability is a significant visual and interactive improvement over the single eye view.

The present invention also allows the viewer to move around the three dimensional display and yet suffer no great distortion since the display can track the viewer eyepoint and re-display the images correspondingly, in contrast to the conventional prior art three dimensional image display where it would be projected and computed as seen from a singular viewing point, and thus any movement by the viewer away from the intended viewing point in space would cause gross distortion.

The display system can further comprise a computer capable of re-calculate the projected image given the movement of the eyepoint location. The horizontal perspective images can be very complex, tedious to create, or created in ways that are not natural for artists or cameras, and therefore require the use of a computer system for the tasks. To display a three-dimensional image of an object with complex surfaces or to create animation sequences would demand a lot of computational power and time, and therefore it is a task well suited to the computer. Three dimensional capable electronics and computing hardware devices and real-time computer-generated three dimensional computer graphics have advanced significantly recently with marked innovations in visual, audio and tactile systems, and have producing excellent hardware and software products to generate realism and more natural computer-human interfaces.

The horizontal perspective display system of the present invention are not only in demand for entertainment media such as televisions, movies, and video games but are also needed from various fields such as education (displaying three-dimensional structures), technological training (displaying three-dimensional equipment). There is an increasing demand for three-dimensional image displays, which can be viewed from various angles to enable observation of real objects using object-like images. The horizontal perspective display system is also capable of substitute a computer-generated reality for the viewer observation. The systems may include audio, visual, motion and inputs from the user in order to create a complete experience of three dimensional illusions.

The input for the horizontal perspective system can be two dimensional image, several images combined to form one single three dimensional image, or three dimensional model. The three dimensional image or model conveys much more information than that a two dimensional image and by changing viewing angle, the viewer will get the impression of seeing the same object from different perspectives continuously.

The horizontal perspective display can further provide multiple views or “Multi-View” capability. Multi-View provides the viewer with multiple and/or separate left- and right-eye views of the same simulation. Multi-View capability is a significant visual and interactive improvement over the single eye view. In Multi-View mode, both the left eye and right eye images are fused by the viewer's brain into a single, three-dimensional illusion. The problem of the discrepancy between accommodation and convergence of eyes, inherent in stereoscopic images, leading to the viewer's eye fatigue with large discrepancy, can be reduced with the horizontal perspective display, especially for motion images, since the position of the viewer's gaze point changes when the display scene changes.

In Multi-View mode, the objective is to simulate the actions of the two eyes to create the perception of depth, namely the left eye and the right eye sees slightly different images. Thus Multi-View devices that can be used in the present invention include methods with glasses such as anaglyph method, special polarized glasses or shutter glasses, methods without using glasses such as a parallax stereogram, a lenticular method, and mirror method (concave and convex lens).

In anaglyph method, a display image for the right eye and a display image for the left eye are respectively superimpose-displayed in two colors, e.g., red and blue, and observation images for the right and left eyes are separated using color filters, thus allowing a viewer to recognize a stereoscopic image. The images are displayed using horizontal perspective technique with the viewer looking down at an angle. As with one eye horizontal perspective method, the eyepoint of the projected images has to be coincide with the eyepoint of the viewer, and therefore the viewer input device is essential in allowing the viewer to observe the three dimensional horizontal perspective illusion. From the early days of the anaglyph method, there are much improvements such as the spectrum of the red/blue glasses and display to generate much more realism and comfort to the viewers.

In polarized glasses method, the left eye image and the right eye image are separated by the use of mutually extinguishing polarizing filters such as orthogonally linear polarizer, circular polarizer, elliptical polarizer. The images are normally projected onto screens with polarizing filters and the viewer is then provided with corresponding polarized glasses. The left and right eye images appear on the screen at the same time, but only the left eye polarized light is transmitted through the left eye lens of the eyeglasses and only the right eye polarized light is transmitted through the right eye lens.

Another way for stereoscopic display is the image sequential system. In such a system, the images are displayed sequentially between left eye and right eye images rather than superimposing them upon one another, and the viewer's lenses are synchronized with the screen display to allow the left eye to see only when the left image is displayed, and the right eye to see only when the right image is displayed. The shuttering of the glasses can be achieved by mechanical shuttering or with liquid crystal electronic shuttering. In shuttering glass method, display images for the right and left eyes are alternately displayed on a CRT in a time sharing manner, and observation images for the right and left eyes are separated using time sharing shutter glasses which are opened/closed in a time sharing manner in synchronism with the display images, thus allowing an observer to recognize a stereoscopic image.

Other way to display stereoscopic images is by optical method. In this method, display images for the right and left eyes, which are separately displayed on a viewer using optical means such as prisms, mirror, lens, and the like, are superimpose-displayed as observation images in front of an observer, thus allowing the observer to recognize a stereoscopic image. Large convex or concave lenses can also be used where two image projectors, projecting left eye and right eye images, are providing focus to the viewer's left and right eye respectively. A variation of the optical method is the lenticular method where the images form on cylindrical lens elements or two dimensional array of lens elements.

FIG. 16 is a horizontal perspective display focusing on how the computer-generated person's two eye views are projected onto the Horizontal Plane and then displayed on a stereoscopic 3D capable viewing device. FIG. 16 represents one complete display time period. During this display time period, the horizontal perspective display needs to generate two different eye views, because in this example the stereoscopic 3D viewing device requires a separate left- and right-eye view. There are existing stereoscopic 3D viewing devices that require more than a separate left- and right-eye view, and because the method described here can generate multiple views it works for these devices as well.

The illustration in the upper left of FIG. 16 shows the Angled Camera point for the right eye after the first (right) eye-view to be generated. Once the first (right) eye view is complete, the horizontal perspective display starts the process of rendering the computer-generated person's second eye (left-eye) view. The illustration in the lower left of FIG. 16 shows the Angled Camera point for the left eye after the completion of this time. But before the rendering process can begin, the horizontal perspective display makes an adjustment to the Angled Camera point to account for the difference in left and right eye position. Once the horizontal perspective display has incremented the Angled Camera point's x coordinate, the rendering continues by displaying the second (left-eye) view.

Depending on the stereoscopic 3D viewing device used, the horizontal perspective display continues to display the left- and right-eye images, as described above, until it needs to move to the next display time period. An example of when this may occur is if the bear cub moves his paw or any part of his body. Then a new and second Simulated Image would be required to show the bear cub in its new position. This new Simulated Image of the bear cub, in a slightly different location, gets rendered during a new display time period. This process of generating multiple views via the nonstop incrementing of display time continues as long as the horizontal perspective display is generating real-time simulations in stereoscopic 3D.

By rapidly display the horizontal perspective images, three dimensional illusion of motion can be realized. Typically, 30 to 60 images per second would be adequate for the eye to perceive motion. For stereoscopy, the same display rate is needed for superimposed images, and twice that amount would be needed for time sequential method.

The display rate is the number of images per second that the display uses to completely generate and display one image. This is similar to a movie projector where 24 times a second it displays an image. Therefore, 1/24 of a second is required for one image to be displayed by the projector. But the display time could be a variable, meaning that depending on the complexity of the view volumes it could take 1/12 or ½ a second for the computer to complete just one display image. Since the display was generating a separate left and right eye view of the same image, the total display time is twice the display time for one eye image.

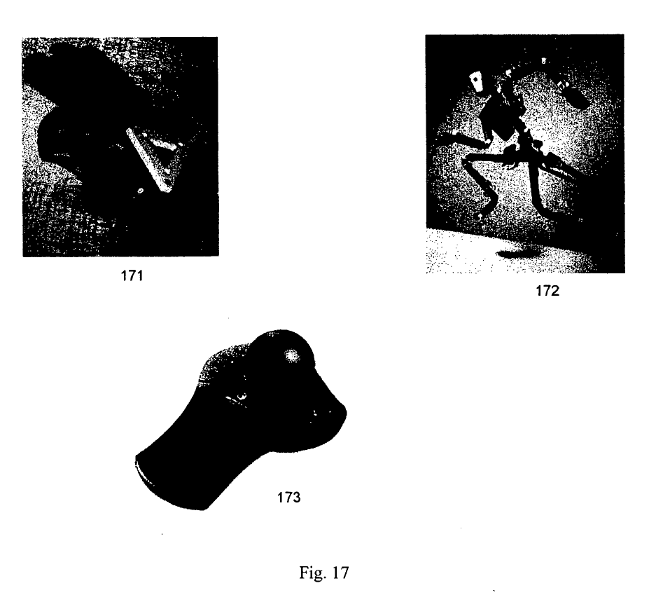

The present invention hands-on simulator further includes technologies employed in computer “peripherals”. FIG. 17 shows examples of such Peripherals with six degrees of freedom, meaning that their coordinate system enables them to interact at any given point in an (x, y, z) space. The simulator creates a “Peripheral Open-Access Volume,” for each Peripheral the end-user requires, such as a Space Glove 171, a Character Animation Device 172, or a Space Tracker 173.

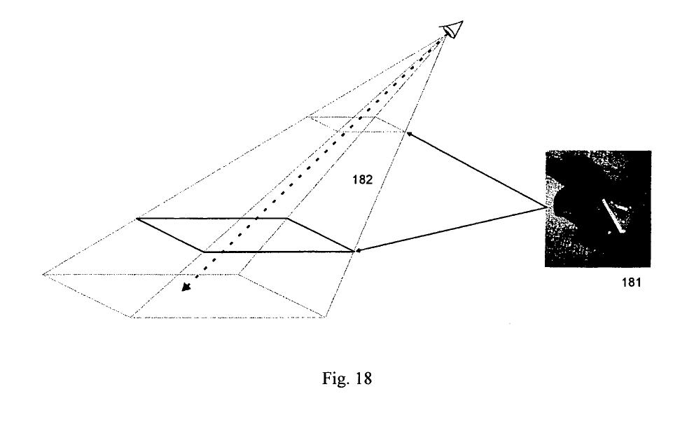

FIG. 18 is a high-level illustration of the Hands-On Simulation Tool, focusing on how a Peripheral's coordinate system is implemented within the Hands-On Simulation Tool. The new Peripheral Open-Access Volume, which as an example in FIG. 18 is a Space Glove 181, is mapped one-to-one with the Open-Access Volume 182. The key to achieving a precise one-to-one mapping is to calibrate the Peripheral's volume with the Common Reference, which is the physical View surface, located at the viewing surface of the display device.

Some Peripherals provide a mechanism that enables the Hands-On Simulation Tool to perform this calibration without any end-user involvement. But if calibrating the Peripheral requires external intervention than the end-user will accomplish this through an “Open-Access Peripheral Calibration” procedure. This procedure provides the end-user with a series of Simulations within the Hands-On Volume and a user-friendly interface that enables them to adjusting the location of the Peripheral's volume until it is in perfect synchronization with the View surface. When the calibration procedure is complete, the Hands-On Simulation Tool saves the information in the end-user's personal profile.

Once the Peripheral's volume is precisely calibrated to the View surface, the next step in the process can be taken. The Hands-On Simulation Tool will continuously track and map the Peripheral's volume to the Open-Access Volumes. The Hands-On Simulation Tool modifies each Hands-On Image it generates based on the data in the Peripheral's volume. The end result of this process is the end-user's ability to use any given Peripheral to interact with Simulations within the Hands-On Volume generated in real-time by the Hands-On Simulation Tool.

With the peripherals linking to the simulator, the user can interact with the display model. The Simulation Engine can get the inputs from the user through the peripherals, and manipulate the desired action. With the peripherals properly matched with the physical space and the display space, the simulator can provide proper interaction and display. The invention Hands-On Simulator then can generate a totally new and unique computing experience in that it enables an end user to interact physically and directly (Hands-On) with real-time computer-generated 3D graphics (Simulations), which appear in open space above the viewing surface of a display device, i.e. in the end user's own physical space. The peripheral tracking can be done through camera triangulation or through infrared tracking devices.

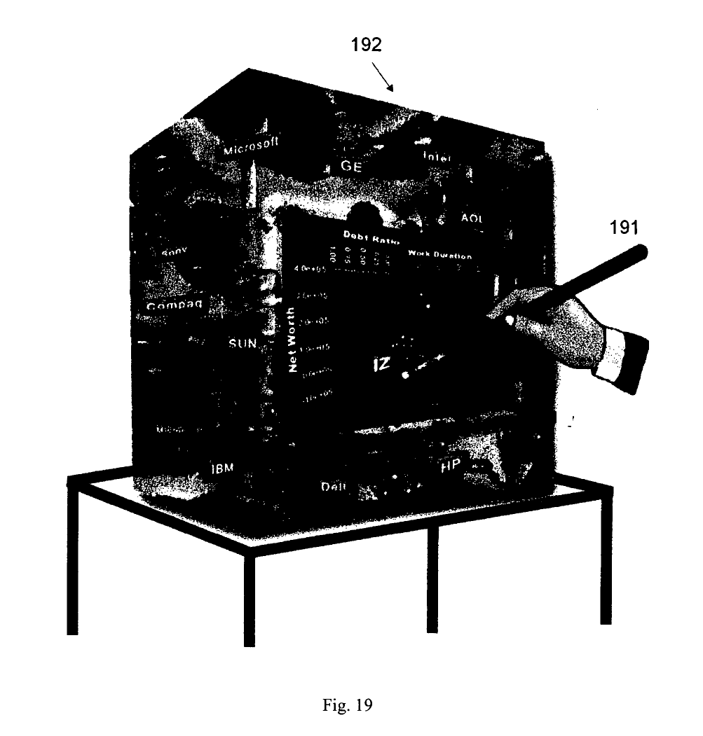

FIG. 19 is intended to assist in further explaining the present invention regarding the Open-Access Volume and handheld tools. FIG. 19 is a simulation of and end-user interacting with a Hands-On Image using a handheld tool. The scenario being illustrated is the end-user visualizing large amounts of financial data as a number of interrelated Open-Access 3D simulations. The end-user can probe and manipulated the Open-Access simulations by using a handheld tool, which in FIG. 19 looks like a pointing device.

A “computer-generated attachment” is mapped in the form of an Open-Access computer-generated simulation onto the tip of a handheld tool, which in FIG. 19 appears to the end-user as a computer-generated “eraser”. The end-user can of course request that the Hands-On Simulation Tool map any number of computer-generated attachments to a given handheld tool. For example, there can be different computer-generated attachments with unique visual and audio characteristics for cutting, pasting, welding, painting, smearing, pointing, grabbing, etc. And each of these computer-generated attachments would act and sound like the real device they are simulating when they are mapped to the tip of the end-user's handheld tool.

The simulator can further include 3D audio devices for “SIMULATION RECOGNITION & 3D AUDIO ”. This results in a new invention in the form of a Hands-On Simulation Tool with its Camera Model, Horizontal Multi-View Device, Peripheral Devices, Frequency Receiving/Sending Devices, and Handheld Devices as described below.

Object Recognition is a technology that uses cameras and/or other sensors to locate simulations by a method called triangulation. Triangulation is a process employing trigonometry, sensors, and frequencies to “receive” data from simulations in order to determine their precise location in space. It is for this reason that triangulation is a mainstay of the cartography and surveying industries where the sensors and frequencies they use include but are not limited to cameras, lasers, radar, and microwave. 3D Audio also uses triangulation but in the opposite way 3D Audio “sends” or projects data in the form of sound to a specific location. But whether you're sending or receiving data the location of the simulation in three-dimensional space is done by triangulation with frequency receiving/sending devices. By changing the amplitudes and phase angles of the sound waves reaching the user's left and right ears, the device can effectively emulate the position of the sound source. The sounds reaching the ears will need to be isolated to avoid interference. The isolation can be accomplished by the use of earphones or the like.

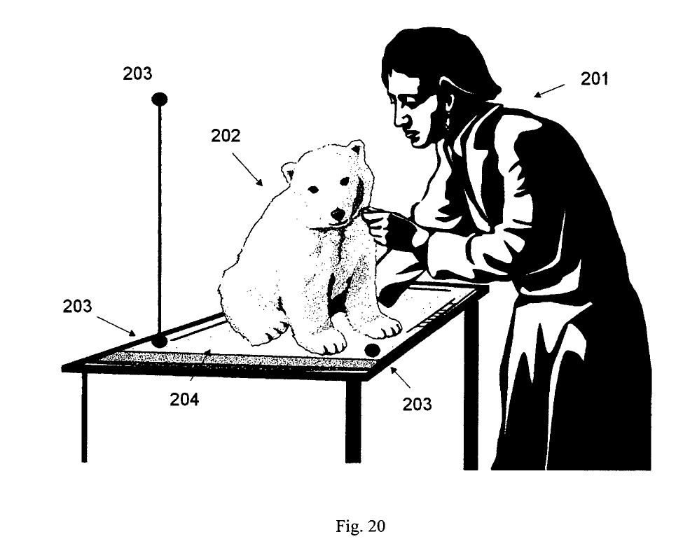

FIG. 20 shows an end-user 201 looking at a Hands-On Image 202 of a bear cub, projecting from a 3D horizontal perspective display 204. Since the cub appears in open space above the viewing surface the end-user can reach in and manipulate the cub by hand or with a handheld tool. It is also possible for the end-user to view the cub from different angles, as they would in real life. This is accomplished though the use of triangulation where the three real-world cameras 203 continuously send images from their unique angle of view to the Hands-On Simulation Tool. This camera data of the real world enables the Hands-On Simulation Tool to locate, track, and map the end-user's body and other real-world simulations positioned within and around the computer monitor's viewing surface.

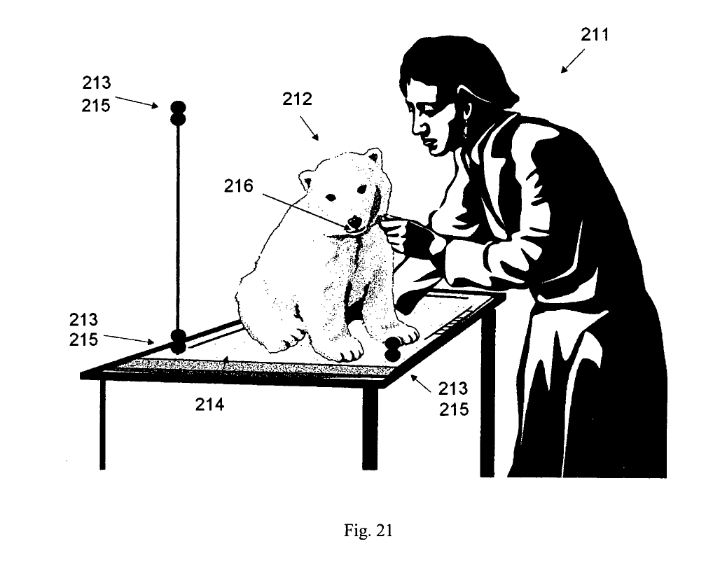

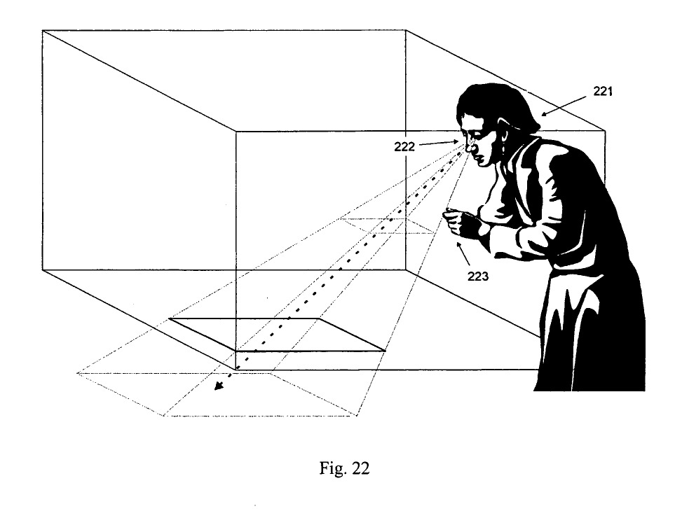

FIG. 21 also shows the end-user 211 viewing and interacting with the bear cub 212 using a 3D display 214, but it includes 3D sounds 216 emanating from the cub's mouth. To accomplish this level of audio quality requires physically combining each of the three cameras 213 with a separate speaker 215, as shown in FIG. 21. The cameras' data enables the Hands-On Simulation Tool to use triangulation in order to locate, track, and map the end-user's “left and right ear”. And since the Hands-On Simulation Tool is generating the bear cub as a computer-generated Hands-On Image it knows the exact location of the cub's mouth. By knowing the exact location of the end-user's ears and the cub's mouth the Hands-On Simulation Tool uses triangulation to sends data, by modifying the spatial characteristics of the audio, making it appear that 3D sound is emanating from the cub's computer-generated mouth.

A new frequency receiving/sending device can be created by combining a video camera with an audio speaker, as previously shown in FIG. 21. Note that other sensors and/or transducers may be used as well.

Take these new camera/speaker devices and attach or place them nearby a viewing device, such as a computer monitor as previously shown in FIG. 21. This results in each camera/speaker device having a unique and separate “real-world” (x, y, z) location, line-of-sight, and frequency receiving/sending volume. To understand these parameters think of using a camcorder and looking through its view finder When you do this the camera has a specific location in space, is pointed in a specific direction, and all the visual frequency information you see or receive through the view finder is its “frequency receiving volume”.

Triangulation works by separating and positioning each camera/speaker device such that their individual frequency receiving/sending volumes overlap and cover the exact same area of space. If you have three widely spaced frequency receiving/sending volumes covering the exact same area of space than any simulation within the space can accurately be located. The next step creates a new element in the Open-Access Camera Model for this real-world space and labeled “real frequency receiving/sending volume”.

Now that this real frequency receiving/sending volume exists it must be calibrated to the Common Reference, which of course is the real View Surface. The next step is the automatic calibration of the real frequency receiving/sending volume to the real View Surface. This is an automated procedure that is continuously performed by the Hands-On Simulation Tool in order to keep the camera/speaker devices correctly calibrated even when they are accidentally bumped or moved by the end-user, which is likely to occur.

FIG. 22 is a simplified illustration of the complete Open-Access Camera Model and will assist in explaining each of the additional steps required to accomplish the scenarios described above. The simulator then performs simulation recognition by continuously locating and tracking the end-user's “left and right eye” and their “line-of-sight” 221. The real-world left and right eye coordinates are continuously mapped into the Open-Access Camera Model precisely where they are in real space, and then continuously adjust the computer-generated cameras coordinates to match the real-world eye coordinates that are being located, tracked, and mapped. This enables the real-time generation of Simulations within the Hands-On Volume based on the exact location of the end-user's left and right eye. This allows the end-user to freely move their head and look around the Hands-On Image without distortion.

The simulator then performs simulation recognition by continuously locating and tracking the end-user's “left and right ear” and their “line-of-hearing” 222. The real-world left- and right-ear coordinates are continuously mapped into the Open-Access Camera Model precisely where they are in real space, and continuously adjust the 3D Audio coordinates to match the real-world ear coordinates that are being located, tracked, and mapped. This enables the real-time generation of Open-Access sounds based on the exact location of the end-user's left and right ears. Allowing the end-user to freely move their head and still hear Open-Access sounds emanating from their correct location.

The simulator then performs simulation recognition by continuously locating and tracking the end-user's “left and right hand” and their “digits” 222, i.e. fingers and thumbs. The real-world left and right hand coordinates are continuously mapped into the Open-Access Camera Model precisely where they are in real space, and continuously adjust the Hands-On Image coordinates to match the real-world hand coordinates that are being located, tracked, and mapped. This enables the real-time generation of Simulations within the Hands-On Volume based on the exact location of the end-user's left and right hands allowing the end-user to freely interact with Simulations within the Hands-On Volume.

Alternatively or additionally, the simulator can perform simulation recognition by continuously locating and tracking “handheld tools” instead of hand. These real-world handheld tool coordinates can be continuously mapped into the Open-Access Camera Model precisely where they are in real space, and continuously adjust the Hands-On Image coordinates to match the real-world handheld tool coordinates that are being located, tracked, and mapped. This enables the real-time generation of Simulations within the Hands-On Volume based on the exact location of the handheld tools allowing the end-user to freely interact with Simulations within the Hands-On Volume.

A 3D horizontal perspective hands-on simulator is disclosed. While the preferred forms of the invention have been shown in the drawings and described herein, the invention should not be construed as limited to the specific forms shown and described, since variations of the preferred forms will be apparent to those skilled in the art. Thus the scope of the invention is defined by the following claims and their equivalents.

1. A 3-D horizontal perspective simulator system comprising
a horizontal perspective display using horizontal perspective to display a 3-D image onto an open space; and
a peripheral device to manipulate the display image by touching the 3-D image.

2. A simulator system as in claim 1 further comprising a processing unit taking the input from the peripheral device and providing output to the horizontal perspective display.

3. A simulator system as in claim 1 further comprising a means to track the physical peripheral device to the 3-D image.

4. A simulator system as in claim 1 further comprising a means to calibrate the physical peripheral device to the 3-D image.

5. A 3-D horizontal perspective simulator system comprising
a processing unit;
a horizontal perspective display using horizontal perspective to display a 3-D image onto an open space;
a peripheral device to manipulate the display image by touching the 3-D image; and
a peripheral device tracking unit for mapping the peripheral device to the 3-D image.

6. A simulator system as in claim 5 wherein the horizontal perspective display further display a portion of the 3-D image onto an inner-access volume, whereby the image portion in the inner-access volume cannot be touched by the peripheral device.

7. A simulator system as in claim 5 wherein the horizontal perspective display further comprises automatic or manual eyepoint tracking.

8. A simulator system as in claim 5 wherein the horizontal perspective display further comprises a means to zoom, rotation or movement of the 3-D image.

9. A simulator system as in claim 5 wherein the horizontal perspective display projects the 3-D image onto a substantial horizontal surface.

10. A simulator system as in claim 5 wherein the peripheral device is a tool, a handheld tool, a space glove or a pointing device.

11. A simulator system as in claim 5 wherein the peripheral device comprises a tip wherein the manipulation corresponds to the tip of the peripheral device.

12. A simulator system as in claim 5 wherein the manipulation comprises the action of modifying the display image or the action of generating a different image.

13. A simulator system as in claim 5 further comprising a 3-D sound system.

14. A simulator system as in claim 5 wherein the peripheral device mapping comprises inputting the position of the peripheral device to the processing unit.

15. A simulator system as in claim 5 wherein the peripheral device tracking unit comprises a triangulation or infrared tracking system.

16. A simulator system as in claim 5 further comprising a means to calibrate the coordinate of the display image to the peripheral device.

17. A simulator system as in claim 16 wherein the calibration means comprises a manual input of a reference coordinate.

18. A simulator system as in claim 16 wherein the calibration means comprises an automatic input of a reference coordinate through a calibration procedure.

19. A simulator system as in claim 5 wherein the horizontal perspective display is a stereoscopic horizontal perspective display using horizontal perspective to display a stereoscopic 3-D image.

20. A multi-view 3-D horizontal perspective simulator system comprising
a processing unit;
a stereoscopic horizontal perspective display using horizontal perspective to display a stereoscopic 3-D image onto an open space; and
a peripheral device to manipulate the display image by touching the 3-D image; and
a peripheral device tracking unit for mapping the peripheral device to the 3-D image.
